(19) United States
(12) Patent Application Publication
(10) Pub. No.: US 2018/0273072 A1
(43) Pub. Date: Sep. 27, 2018

(54) System for Storing Products

(71) Applicant: Pickdelso Oy, Vantaa (FI)

(72) Inventor: Tapio SAVIRANTA, Vantaa (FI)

(21) Appl. No.: 15/571,261

(22) PCT Filed: May 18, 2016
(86) PCT No.: PCT/FI2016/050335

§ 371 Date: Nov. 1, 2017

(30) Foreign Application Priority Data
May 18, 2015 (FI) 20155359

(51) Int. Cl. B62B 3/00; B62B 3/14

(52) U.S. Cl. CPC B62B 3/005; B62B 3/146

(57) ABSTRACT

An invention relates to picking and storing of products and one of its objectives is to reduce manual work. The invention concerns a system for storing the products, wherein the system comprises a wall (301) with openings (304), (305) that enable reaching a first repository (302) and a second repository (303) from a customer side (306) of the wall, and closures (307), (308) in the wall to cover and disclose the openings. The system further comprises a cart (310) for picking the products during a picking stage, the cart including the first repository (302) and the second repository (303). The system is configured to receive the cart into a parking place (309) beside the wall so that the first repository (302) is reachable through a first opening and the second repository is reachable through a second opening. A repository included in the system is configured to receive a tote (205), (206) or a container (201), (203), (213) so that 1) the repository's (302), (303) bottom (405), (406) is located at a horizontal plane or the repository is tilted to at most 45 degrees angle in relation to the horizontal plane in order to hold a product inside the tote or the container, and 2) the repository supports the tote (205), (206) or the container (201), (203), (213) keeping a mouth of the tote or the container open, and 3) during the picking stage, said mouth is continuously at least partly disclosed for receiving the products into the tote or the container.

Area of technology: an invention relates to picking and storing of products; the invention especially relates to manners to reduce manual work.

### BACKGROUND OF THE TECHNOLOGY

Foodstuff and other grocery products can be ordered from internet and later on the products ordered are delivered to certain addresses, for example, to the home address of a subscriber. This kind of service contains at least an ordering stage and a picking stage for picking the products. A collector, i.e. the person who performs the picking stage, collects the products to totes and/or containers, such as boxes. A plastic bag and a paper bag are typical totes. After the picking stage the containers and/or totes with products are moved to a delivery vehicle, if the products are to be transported to customers. Alternatively, the products are placed in a parcel automaton, if the customers will fetch the products. Regarding the invention, products are of various kinds and they are usually small-sized compared to the volume of a tote or a container.

FIG. 1 shows a cart 101 viewed from the long side as well as from the short side. Cart 101 contains six repositories, i.e. spaces for the same amount of boxes. The dimensions of a box are, for example, 60×40×30 cm. The six boxes 102-107 are placed in three layers. During the picking stage it is easy to place a collected product to either the two topmost boxes 102, 105. In contrast, four boxes are placed under some other box. For example, box 103 must be slid outwards on drawer slides to place a product in it. Cart 101 has such a drawback that boxes 103, 104, 106, 107 has to be opened and closed repeatedly during the picking and this increases the picking time.

GB 2362704 represents the prior art for the present invention. The publication describes a cart which comprises locker doors so that customers can take theirs purchases through the locker doors. The cart is not intended for picking of products and is inappropriate for that purpose. DE 19716138 represents another prior art system. The publication describes a system comprising a cart with lockers and a separated wall. The wall includes the locker doors through which the lockers of the cart are reachable. U.S. Pat. No. 7,407,238 represents another prior art system. The publication describes a system comprising a cart with shelves and a separated wall. The wall includes the locker doors through which the shelves of the cart are reachable.

The prior art systems have the following drawbacks. In GB 2362704 the locker doors of the cart makes the picking of products difficult. In DE 19716138, which can be considered to represent the closest prior art, the lockers open to the side so that products may drop from the lockers. A locker opening to the side is appropriate for a single packet but not for an order including a number of products, because such locker provides no support for a plastic bag into which the products could be picked. Another drawback is that a customer should easily obtain the plastic bag, or another tote or a container that includes the products ordered. The same drawbacks concern the system of U.S. Pat. No. 7,407,238.

### SUMMARY OF THE INVENTION

An objective of the invention is to solve the above-mentioned drawbacks. Another objective is to reduce manual work. Another objective is to eliminate lifting of totes or containers into the repositories of a system when products are picked into the totes or containers and the picking stage ends.

The invention concerns a system for storing products, the system comprising

a wall with openings that enable reaching a first repository and a second repository from a customer side of the wall,

closures in the wall to cover and disclose the openings, and

a cart for picking the products during a picking stage, the cart including the first repository and the second repository and the system being configured to receive the cart into a parking place beside the wall so that the first repository is reachable through a first opening and the second repository is reachable through a second opening.

A repository included in the system (in accordance with the invention) is configured to receive a tote or a container so that

the repository's bottom is located at a horizontal plane or the repository is tilted to at most 45 degrees angle in relation to the horizontal plane in order to hold a product inside the tote or the container, and

the repository supports the tote or the container keeping a mouth of the tote or the container open, and during the picking stage,

said mouth is continuously at least partly disclosed for receiving the products into the tote or the container.

In one embodiment the system is configured to reserve at least two repositories for an order when a volume of products included in the order exceeds a volume of a single repository.

In one embodiment the system is configured to open at least two closures in response to inputting an acceptable code.

In one embodiment the system comprises encapsulation and a cooling arrangement.

In one embodiment the cooling arrangement comprises one of the following components: a refrigerator apparatus, a cooling gel, a Peltier element.

In one embodiment the cooling arrangement comprises a supply air pipe and an exhaust air pipe.

In one embodiment the system comprises an identifier for indicating the parking place intended for the cart.

In one embodiment the system is configured to check by a control unit which repositories are reserved and to deem the cart to be free when the all repositories of the cart are empty.

In one embodiment the first repository and the second repository are located on shelves of which one is a movable shelf and another is a fixed shelf.

In one embodiment the wall comprises a protrusion for pulling of the container outwards from the wall so that an opposite side of the container, in relation to a handle intended for the pulling the container, remains on the protrusion when the container is out of the wall.

In one embodiment the system further comprises a second wall and repositories which are reachable through the second wall when the cart is received between the wall and the second wall.

In one embodiment the cart is configured to a picking usage so that a displacer included in the cart has an open position and the displacer remains in the open position when moving the cart during the picking stage, the displacer and the first repository disclosing in the open position at least partly the second repository.

In one embodiment, in addition said mouth the container comprises a side opening so that the first repository is reachable through the side opening when the cart is received into the parking place.

In one embodiment the system comprises brackets for supporting a handle of the tote so that the brackets are located opposite to each other on the both sides of the side opening of the container.

In one embodiment a space limited by an outer wall of a set of repositories is divided by at least one dividing wall into at least two repositories.

### BRIEF DESCRIPTION OF THE DRAWINGS

For a more complete understanding of examples and embodiments of the present invention, reference is now made to the following descriptions taken in connection with the accompanying drawings in which:

FIG. 1 shows a prior art cart,

FIG. 2A shows conventional repositories and totes,

FIG. 2B shows a container with an opening and a side opening,

FIG. 3 shows a system according to the invention,

FIG. 4A shows a first embodiment for a repository,

FIG. 4B shows a second embodiment for a repository,

FIG. 4C shows a third embodiment for a repository,

FIG. 5 shows some optional components of the system,

FIG. 6A shows a wall and a cart from a bird's eye view,

FIG. 6B shows use of the system,

FIG. 7 shows a method for controlling the picking work,

FIG. 8 shows an example of the first embodiment,

FIG. 9 shows an example of the second embodiment,

FIG. 10A shows a cart in the picking stage in the third embodiment,

FIG. 10B shows the cart parked besides the wall,

FIG. 11 shows an example of a third embodiment,

FIG. 12A shows brackets for a container,

FIG. 12B shows a set of repositories,

FIG. 13 shows a hinged wall.

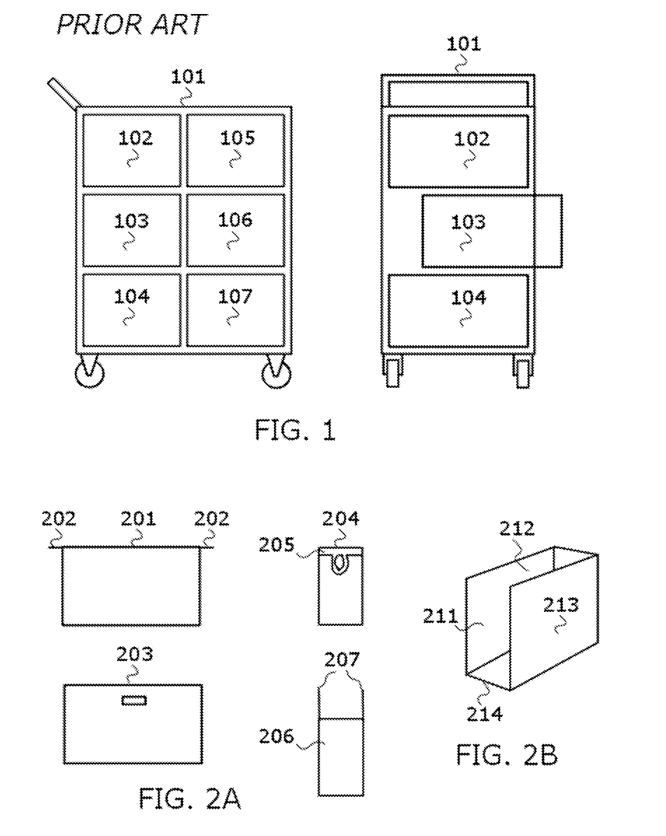

### DETAILED DESCRIPTION OF THE INVENTION

It is appreciated that the following embodiments are exemplary. Although the specification may refer to “one” embodiment, the reference is not necessarily made to the same embodiment(s), or the feature in question may apply to multiple embodiments.

FIG. 2A shows conventional containers and totes from a side view. The container 201 is a box with the following example dimensions: the opening 60×40 cm, the height 30 cm, and the volume 70 l. The edges of box 201 are folded 90 degrees, so that box 201 can hang from its folded edges 202 between the pair of drawer grooves. A box 203 has straight edges. The both boxes 201, 203 may have handles which are formed on the short sides, the long sides, or on the both sides of the box. Containers may be manufactured, for example, plastic, aluminium, steel, or stainless steel.

The container 204 is a bucket with the following example dimensions: the opening 16×32 cm, the height 36 cm, and the volume 18 l. A plastic bag 205 has been placed inside bucket 204. The dimensions of the bag are, for example, the opening 15×30 cm, the height 40 cm and the volume 18 l. In other words, bucket 204 and plastic bag 205 have such dimensions that the bucket supports the plastic bag and keeps its mouth open. The edges and handles of plastic bag 205 are folded over the edges of bucket 204 so that the collector can put products inside plastic bag 205. The customer can take the products out of bucket 204 by pulling the handles of plastic bag 205. A tote 206 is made of paper, cardboard or (thick) fabric and tote 206 can be called as a fibre bag. Unlike a plastic bag, a fibre bag supports itself, for which reason it does not need to be supported by the container. Thus, fibre bag 206 with handles 207 will remain upright, the opening wide open, which makes easy to collect products in it.

FIG. 2B shows a container having a side opening 211 and an opening 212, wherein opening 212 opens upwards relative to the bottom of this container 213. Side opening 211 can be accomplished by omitting one (short) side of container 213. A tote, such as fibre bag 206, is placed inside container 213 and then the collector can be put the products inside the fibre bag 206 through opening 212 of container 213. After picking the products, fibre bag 206 is pulled, through side opening 211, out of container 213. Alternatively, a plastic bag can be used as a tote so that the edges of the plastic bag are folded over the edges of container 213. In this manner, the plastic bag is supported and its mouth stays open for the products to be placed in.

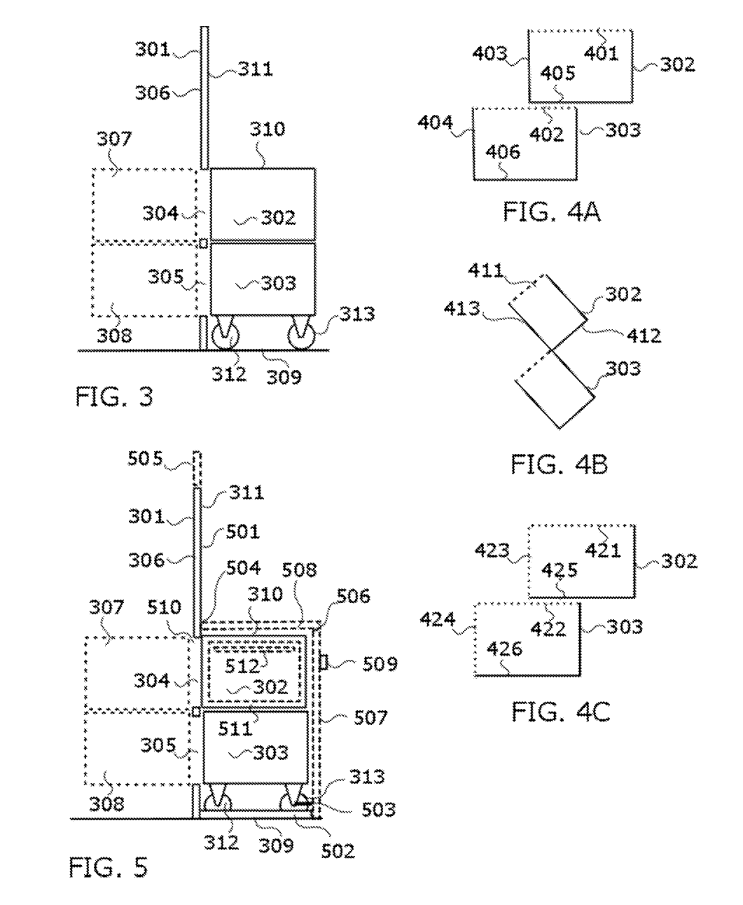

FIG. 3 shows the operation principle of the system when the system is intended for temporary storage of grocery products, consumer goods such as electrical goods, or other retail or wholesale trade products. The products stored in the system are possibly ordered online. Rules for limiting the storage time can be defined in various ways. For example, an owner of the system may require that the products should be fetched within 24 hours. Alternatively, a customer may be given an opportunity to choose, for example, a 2-hour-long time window so that the customer commits to fetch the products within a certain time window and the system owner commits to perform the picking by the beginning of the customer's time window.

The system comprises a wall 301 and repositories 302, 303 which are adapted to receive a tote or a container inside them. The system is best suited for small-sized products, because a large number of them can be placed in a tote or a container.

The system comprises openings 304, 305 on a customer side 306 of the wall so that the first repository 302 is accessible through a first opening 304 and the second repository 303 is accessible through the second opening 305. Accessibility means that it is possible to take products out of the repository. In other words, each repository is equipped with an access route. In addition, the system comprises closures 307, 308 to cover the openings so that the first closure 307 is adapted to cover the first opening and second closure 308 is adapted to cover the second opening. A hatch or a locker door is a typical example of closure 307, 308. The system also comprises a parking place 309 for a cart 310 on a repository side 311 of wall 301. Cart 310 includes wheels 312, 313 for moving the cart and at least part of the repositories, including the first repository 302 and second repository 303. The system is adapted to receive cart 310 to parking place 309 so that the first repository is situated against the first opening and the second repository is situated against the second opening. Thus, wall 301 and cart 310 must be made in such manner that there are access routes from customer side 306 of the wall to repositories 302, 303. Wall 301 may comprise a number of parking places for carts.

A system unit, which is used in picking and storing of products, is one tote or one container. In other words, repository 302, 303 has size of one tote or container. Let us analyse the prior art systems to understand why a small unit size saves space. In the prior art the repositories are relatively large, such as 70 or 100 l. Nevertheless, sometimes the volume of the products ordered by a customer exceeds 100 litres. Therefore, even a 100 l repository is not large enough for every order. The system in accordance with the invention is different, because a customer can have as many repositories as the customer (at that time) needs. If the customer needs, for example, five repositories for the products ordered, the five repositories are reserved. When the customer comes to fetch the products ordered and inputs a correct code, five locker doors will open and the customer can take the products out of the five repositories.

The small unit size increases the system capacity by approximately 100% compared to the known systems. To explain this, let us consider a system in which a repository is 70 l, i.e. three 23 litre bags can be stored in a single repository. If a customer orders only one bag of products, the repository remains 66% useless space. If the customer orders two bags of products, the repository remains 33% useless space. If the customer orders three bags of products, the repository is full. Let us then assume that a probability for a one, two or three bag order is equal. When using said probability assumption (for the volume of an order) the 70 l repository includes 50% useless space. The amount of the useless space can be substantially reduced by using a smaller unit size. A size of a tote, such a 23 l plastic bag, is an appropriate unit size for consumer clients. Correspondingly, a size of a container, such as a 70 l box, is an appropriate unit size for enterprise clients assuming that their orders usually include several boxes of products.

The FIGS. 4A-4C show different embodiments concerning the implementation of the repositories. Each repository 302, 303 should be understood as a physically limited space which is configured to receive a tote 205, 206 or a container 201, 203, 213 so that the tote or container is properly supported. In addition, during the picking stage, the mouth of the tote or container is continuously at least partly disclosed (at least half open) for receiving the products into the tote or container.

FIG. 4A shows the first embodiment of the system, wherein the first repository 302 and second repository 303 includes boxes, such as boxes 201, 203. Repositories 302, 303 have openings 401, 402 and their sides 403, 404 are located on different planes during the picking stage. After the picking stage, sides 403, 404 are located on the same plane when cart 310 is parked besides repository side 311 of wall 301. The bottoms 405, 406 of repository 302, 303 are parallel to the ground (the horizontal plane) and the openings 401, 402 open away from bottoms 405, 406.

FIG. 4B shows the second embodiment of the system. In this embodiment repository 302 includes an opening 411 that opens away from the bottom 412 of repository 302 and bottom 412 and/or a side 413 of repository 302 are inclined 45 degrees to the horizontal plane. The inclination prevents products from falling from repository 302. The second repository 303 is inclined 45 degrees in relation to the horizontal plane as first repository 302.

FIG. 4C shows the third embodiment of the system, wherein the first and second repository 302, 303 are implemented by using container 213. Repository 302 includes an opening 421 and a side opening 422. The first repository 302 is reachable through the first opening 304 of wall 301 and through side opening 422. Opening 421 opens away from the bottom 423 of repository 302 and side opening 422 is located approximately 90 degrees to the bottom. A tote placed in repository 302 can be pulled through side opening 422 out of repository 302.

FIG. 5 shows components which can be considered as optional components. In one embodiment, the system includes an identifier 501 to indicate a parking place for cart 310. Identifier 501 may be a letter, a numbers or another symbol. Identifier 501 can be implemented, for example, by painting it on the wall 301.

In one embodiment, the system comprises at least one guide for guiding cart 310 to parking place 309. For example, a guide 502 is a steel edge affixed to the floor that guides cart 310 precisely to its parking place 309.

In one embodiment, the system comprises a fastening arrangement 503 for fastening cart 310 to wall 301. Fastening arrangement 503 prevents vandalism, because without it cart 301 could be pushed through opening 304 off wall 301. Also, the collector may unintentionally move cart 301 out of its parking place. Fastening arrangement 503 is intended to prevent the vehicle movements for malicious or unintentional reasons. In one embodiment fastening arrangement 503 is implemented so that wall 301 includes a part 504 that is attachable to cart 301. Part 504 is, for example, a loop into which a hook attached to the cart can be put.

If the products ordered include food products or other temperature controlled products, repositories 302, 303 need to maintain a certain temperature, for example refrigerator temperatures (2-6° C.). The appropriate temperature can be maintained using air-conditioning and thermally insulated wall 301 that extends from the floor to the ceiling. In this embodiment, the top of wall 301 is called a wall extension 505. Alternatively, the temperature control can be implemented so that encapsulation 506 isolates repository side 311 of wall 301 from the surrounding space. In this embodiment the cooling is required only inside encapsulation 506. Encapsulation 506 is composed of wall 301, side walls 507, and a ceiling 508 which is attached to wall 301 and side walls 507. A pair of doors is attached with hinges to side walls 507. The doors can be used as fastening arrangement 503 when they are capable to hold cart 310 in its parking place. The doors can be locked together with a padlock. The padlock is one example of a locking arrangement 509 for locking cart 310 to its parking place 509. The locking system 509 is intended to prevent thefts or vandalism when customers have an access to repository side 311 of wall 301.

In one embodiment, the system comprises a cooling arrangement 510 and repositories 302, 303 can be flexibly used for storing cool products and/or frozen food. Cooling arrangement 510 can be implemented, for example so that a cooler 512, such as gel ice, is placed in a thermally isolated container 511 that functions as repository 302, 303. In one embodiment, cooling arrangement 510 maintain refrigerator temperature at repository side 311 of wall 301. If a customer order includes frozen foods, thermally insulated containers with coolers can be used as repositories and the frozen products are picked directly to these containers.

In one embodiment, repositories 302, 303 are fixed, i.e. they are containers which are firmly attached to cart 310. In one embodiment, repositories 302, 303 include thermal insulation and each repository has a Peltier element that is switched on, if necessary.

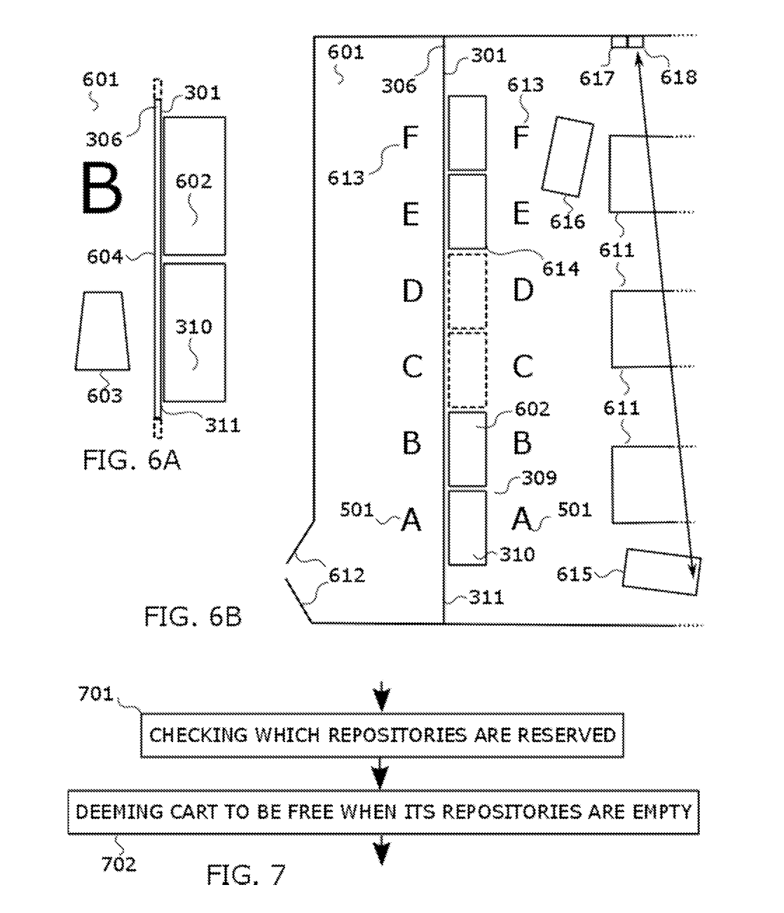

FIG. 6A illustrates wall 301 and cart 310 in a bird's eye view. Wall 301 divides a store 601 to a customer side and a repository side so that the repository side of store 601 is intended for the collectors. The collectors collect customers' purchases to carts and parks the carts against repository side 311 of wall 301. For example, cart 310 and cart 602 are placed against wall 301. A customer can take his/hers purchases from customer side of wall 301, through the locker doors, out of cart 310. Then the customer can put the purchases into a shopping cart 603. If the purchases fit in 1-2 bags, shopping cart 603 may be useless for the customer. In one embodiment, the system includes a user interface 604 embedded in the wall 301. The customer can enter through the user interface, for example, a four-digit code. If the code is correct, the system will open the electronic locks of the locker doors behind which the customer finds his/hers purchases. Alternatively, the user interface is visible on a smart phone display or in another mobile device by which the customer can communicate with the system through a mobile communication network or through some other wireless network.

Text messages (SMS messages) are possible but not the only communication method. Generally speaking, the system provides an access to the repository (or repositories) in response to an input from a customer (or a customer device).

FIG. 6B shows a bird's eye view of the use of the system in store 601. Collectors working on the store collect from shelves 611 purchases for customers. Only a part of shelves 611 and a part of store 601 is shown in the figure. Customers arrive to the store through doors 612 to fetch theirs purchases.

Let us assume that the system user interface is visible in the customer's mobile device. In more detail, the display of the mobile device shows a message to arrive to store 601 to a site ‘A’. Let us assume that the wall 301 includes six parking places for carts and the parking places are marked on the floor with letters 613 (A-F). Here a letter, ‘A’, acts as identifier 501 indicating a parking place of cart 310. When the customer has arrived to store 601 and stands on site ‘A’, he/she is expected to send a message to the system. In response to the customer's message the system opens the locker doors behind which the customer's purchases are located. Then the customer takes the purchases out of the cart 310. Parking places A, B, and F in the figure are reserved, because a cart is parked in each of them and in each cart, which is parked, at least one repository still contains purchases. A cart locating in parking place 614 is empty because the all repositories of the cart are empty. Parking places C and D are empty, as carts 615, 616 of those parking places are currently in use by the collectors. When a cart and its parking place are marked with the same tag, the collector can park the cart in the correct parking place. Alternatively, the system will indicate (with a message) to the collector, to which parking place the cart should be parked.

The system in accordance with the invention may include only mechanical components, such as wall 301 and at least one cart 310. The system, however, may also comprise electronics and/or computers. In one embodiment, the system is adapted to keep track of availability of repositories by means of a computer comprising at least one memory and a processor. In one embodiment, at least one memory and processor are incorporated in a control unit 617 that operates as an ERP (enterprise resource planning) Control unit 617 is configured to conclude a booking situation and choose which cart to use (there may be more than one empty cart). Control unit 617 is connected to a WLAN (wireless local area network) base station or similar communication device 618. In one embodiment, the communication device 618 sends a broadcast message to terminals used by collectors. The message specifies, for example, that the cart having identifier E, i.e. the cart in parking place 614, should be used in the next picking round. Let us assume that a collector using cart 615 has almost ended his/hers picking round and is ready to take cart E and therefore sends an acknowledgement. In response to the acknowledgement, the EPR sends to the collector's terminal a list of the products to be picked into cart E.

FIG. 7 shows a computer implemented method for the system in accordance with the invention. For example, control unit 617 may run the method. The method can check 701 which repositories, including repositories 302, 303, are free and which are reserved, after which the method can determine 702 that a cart is free and available for the picking stage, if the all repositories of the cart are empty.

In one embodiment the cart is judged to be free, when the system has opened the last repository of the cart. Somewhat more complicated embodiment is such that the system includes sensors in repositories, for example, sensors for measuring weight. When using the sensors the cart is determined to be free, if according to the sensors each repository is empty. Nevertheless, a collector must check whether all the repositories of the cart are empty and to act in a predetermined manner, if there are still purchases.

In addition to steps 701 and 702, the method may include one or more optional step. For example, the optional step may concern a free cart so that the free cart's identifier is transmitted to one or more terminals.

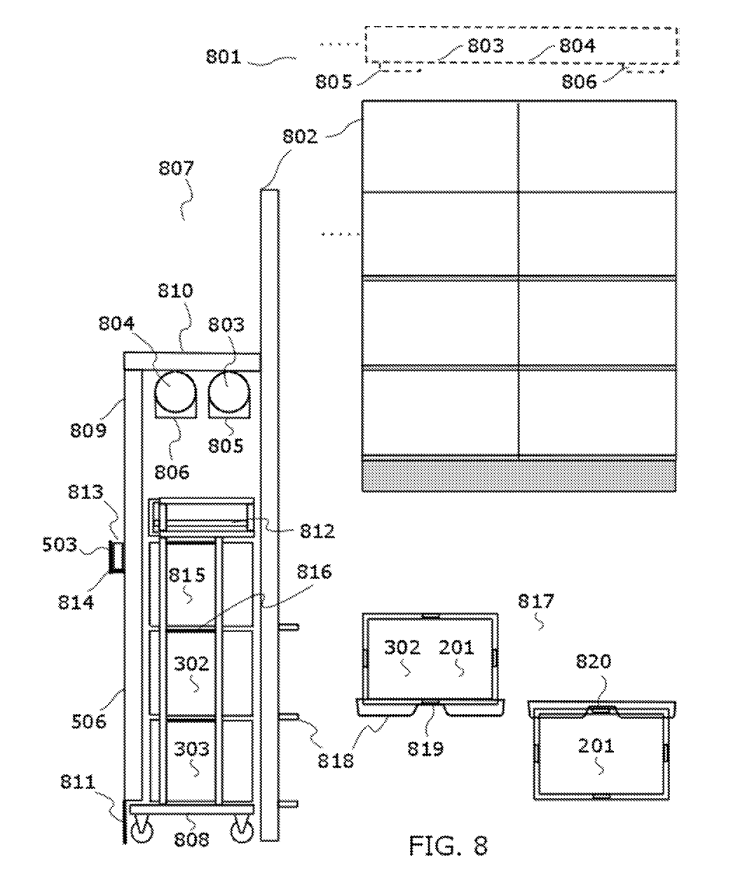

FIG. 8 shows an example of a system according to the first embodiment. A benefit of the first embodiment, compared to the second and third embodiment, is the efficiency when an average order volume is great. In a first view 801, a wall 802 is viewed from the customer side. Wall 802 includes altogether eight locker doors so that a repository and one box in the repository are located behind each locker door. The system is suitable, for example, for wholesale use. The wholesaler's customers may be kiosk, café, or restaurant entrepreneurs. In one embodiment products are picked in deposit boxes which the customers can take with them and return later on. The wholesaler may provide trolleys for the customers so that the customers can move the deposit boxes (and the purchases) from wall 802 to their vans or other vehicles. Wall 802 is a part of encapsulation 506 that maintains a refrigerator temperature. Encapsulation 506 comprises a supply air pipe 803 and an exhaust air pipe 804 and air-conditioning equipment pushes cool air through pipe 803 a supply air valve 805 inside encapsulation 506 and the air-conditioning equipment removes air from there through an exhaust valve 806 and pipe 804. In the first view 801 exhaust air pipe 804 locates behind air supply pipe 803.

Another view 807 shows details about encapsulation 506 and cart 808 parked inside it. The encapsulation 506 is composed of wall 802, side walls 809, and a ceiling 810. Ceiling 810 is attached to wall 802 and side walls 809, and a pair of doors is attached to side walls 809. The pair of doors includes a strip of rubber 811 extending to the floor. Regarding to view 807 we may assume that a collector has opened the pair of doors and pushed cart 808 against wall 802 after which the collector has pushed a movable shelf 812 of cart 808 against wall 302. Finally, the collector has closed the pair of doors and locked them with a latch 813. Latch 813 prevents the cart 808 and its shelves diverging from wall 802. In more detail, the pair of doors, latch 813, and a latch holder 814 attached one of the doors operates as fastening system 503. When the latch 813 is lifted out of the holder 814, cart 808 can be taken to a picking use (in the figure cart 808 is in a storage use). Each repository 302, 303, 815 includes a box 201 with the folded edges 202. Cart 808 comprises a pair of drawer grooves 816 between which the folded edges 202 are pushed so that the box is hanging from the drawer grooves 816.

A third view 817 shows protrusions for helping the handling of containers, such as boxes 201, 203. For example, wall 802 comprises a protrusion 818 for repository 302. A customer can move box 201 outwards from wall 802 by gripping his/hers hand to a handle 819 and pulling box 201 so that an opposite side of box 201, in relation to handle 819, remains on protrusion 818 when box 201 is out of wall 802. Then the customer can grip his/hers other hand to a handle 820 on the opposite side of box 201. Now the customer has a grip on the two handles 819, 820, and can lift box 201, for example, on a trolley.

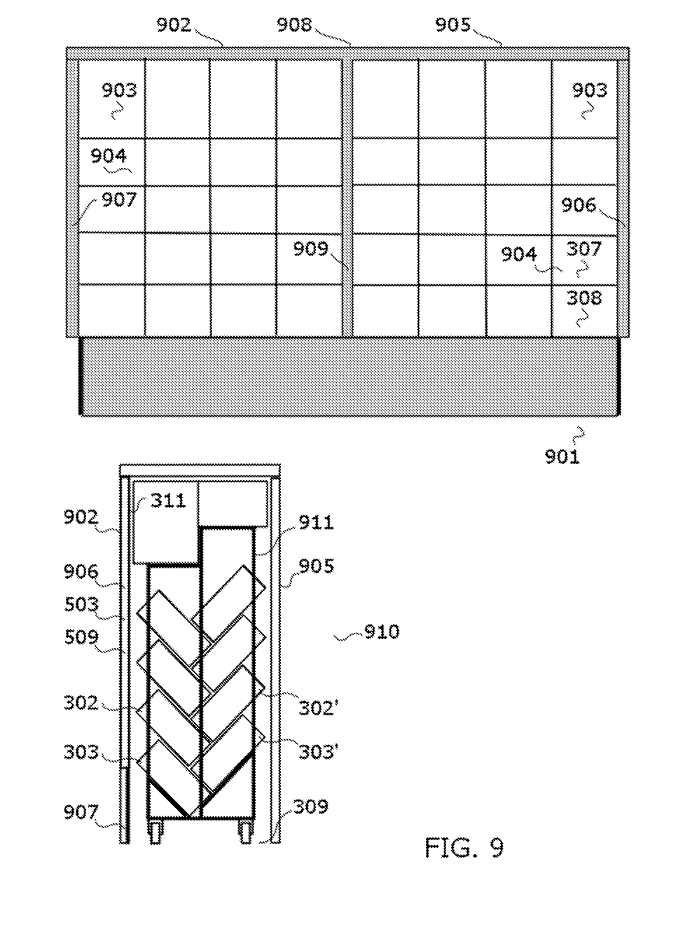

FIG. 9 shows an example of system according to the second embodiment. A benefit of the second embodiment, compared to the first and third embodiment, is that the mouth of a repository is 100% open. In the first view 901, a wall 902 is viewed from the customer side. There are altogether twenty closures 307, 308, i.e. locker doors. Wall 902 is suitable, for example, for a temporary storage of grocery products in shopping centres. Large locker doors 903 at the top of the wall covers repositories for large-sized and light products such as kitchen paper packaging, toilet paper packaging and diapers. Below locker doors 903 the rest locker doors 904 are relatively small-sized. Behind wall 902 there is another similar wall 905 with the locker doors. The two walls 902, 905 and two doors 906 with rubber flaps 907, and ceiling 908 form a thermally insulated encapsulation 506. An apparatus maintaining refrigerator temperature can be placed in ceiling 908 or to a support member 909 connecting walls 902, 905. There a parking place for a cart on the both side of support member 909, i.e. altogether two parking places.

In another view 910, a cart 911 is viewed from its short side. Cart 911 is pushed between two walls 902, 905. A door 906 is attached with hinges to an edge of wall 902 and it is open in view 910. By closing door 906 of cart 911 is simultaneously closed inside encapsulation 506. When door 906 is closed and locked, it keeps the cart 911 in its parking place. Thus, door 906 acts as fastening arrangement 503 and locking arrangement 509. Cart 911 includes repositories 302, 303 placed in a 45-degree angle to the floor. Cart 911 further includes repositories 302′, 303′, which are placed in a 45-degree angle to the floor, but are mirror images for repositories 302, 303. By placing the repositories 302, 302′, 303, 303′ as show in figure, they partly overlap and fill cart 310 quite efficiently. Wall 905 is a mirror image of wall 902 and a half of the repositories are reachable through it.

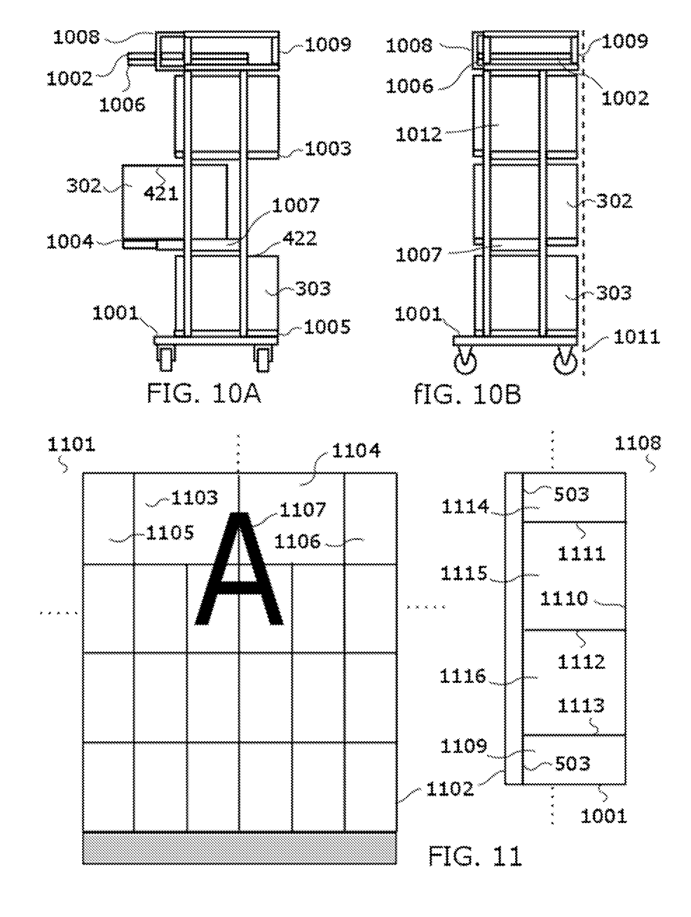

FIG. 10A shows a cart 1001 for the third embodiment of the system, wherein cart 1001 is in the picking use. Cart 1001 comprises movable shelves 1002, 1004, and non-movable shelves i.e. fixed shelves 1003, 1005. Each movable shelf 1002, 1004 comprises a displacer 1006, 1007 which is, for example, a pair of a drawer slides or a pair of slide rails. A telescopic drawer may include three nested slides. Displacers 1006, 1007 for shelves 1002, 1004 are implemented as telescopic drawers. Cart 1001 is configured for picking so that displacers 1006, 1007 have an open position for the picking use and displacers 1006, 1007 remain in the open position when cart 1001 is moved during the picking. The displacer 1007 and the first repository 302 reveal in the open position at least part of the second repository 303, which allows the placement of products via opening 421 into the first repository 302 and via a corresponsive opening into the second repository 303.

In one embodiment, cart 1001 includes handles 1008, 1009 for pushing and guiding the cart. The distance between the handles is adjustable and thus the cart can be narrowed. This feature is useful when cart 1001 is parked inside encapsulation 506.

FIG. 10B shows the cart 1001 in the storage use. As in FIG. 10A cart 1001 is viewed from its end. Movable shelves 1002, 1004 are pushed to their opposite position with telescopic drawers 1006, 1007 and therefore also the repositories located on shelves 1002, 1004 are moved to the opposite position. The corresponsive sides of repositories 302, 303, 1012 locate at the same plane 1011. When the repositories are implemented by means of containers 213 each container 213 includes a side opening 422, through which the plastic bag 205 or fibre bag 206 can be pulled out of the container 213.

FIG. 11 shows an example of the system according to the third embodiment. A benefit of the third embodiment is the repositories utilise the volume of a cart more efficiently than in the second embodiment, and compared to the first embodiment, the unit size is in the third embodiment appropriate for persons and families. In the first view 1101, wall 1102 is viewed from the customer side. Wall 1102 can be placed, for example, in store 601. At the top (of the wall) the locker door 1103, 1104 are quite large, because the repositories behind them are intended for large-sized and light products. The other locker doors, such as locker doors 1105, 1106, are smaller. Altogether 22 repositories can be accessed through as many locker doors. Said 22 repositories are located on shelves 1002-1005 of cart 1001. Dashed lines illustrate that the wall 1102 may be part of a long wall which is composed of several wall parts intended for several carts.

The second view 1108 shows a bird's eye view of a structure 1110 on the upper shelf 1002 of the cart 1001. Structure 1110 can be prepared, for example, steel mesh, plastic, or tempered glass. When structure 1110 is at least partially transparent, it does not cover the collector's field of vision in the picking stage. Structure 1110 prevents products from falling off shelf 1002 and it also prevents theft, because three walls 1111-1113 on shelf 1002 separate repositories 1109, 1114-1116 from each other.

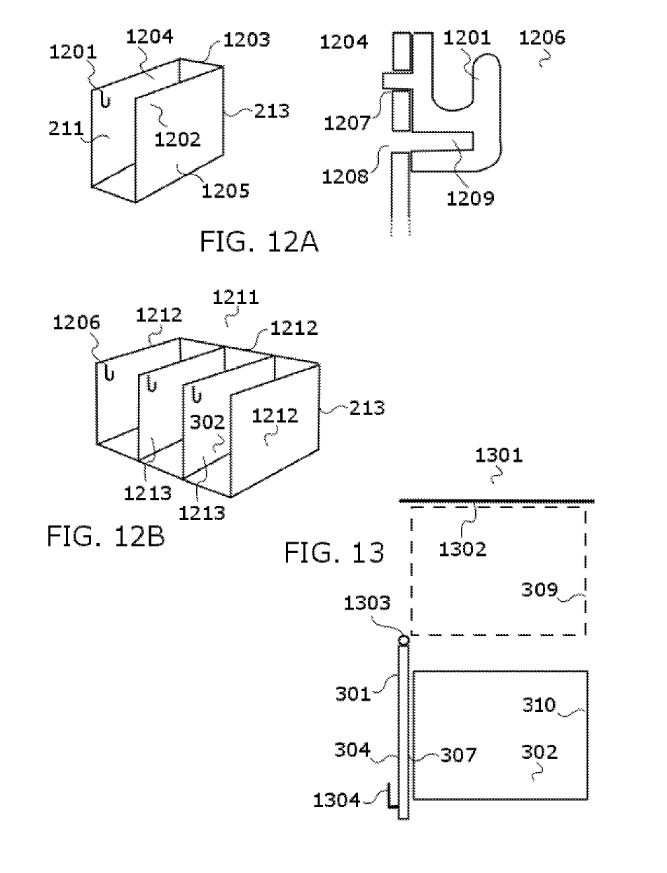

FIG. 12A shows brackets 1201-1203 for container 213. Brackets 1201, 1202 are positioned in the container 213 on opposite sides 1204, 1205 (on inner surfaces of the sides) so that brackets 1201, 1202 are located on the both sides of side opening 211. The brackets 1201, 1202 support a handle of tote 205, 206. Their grip is better when the distance between brackets 1201, 1202 is such they slightly stretch the handle. A third bracket 1203 is intended to support the second handle of tote 205, 206 (bracket 1203 is not visible in figure). The brackets 1201-1203 hold tote's 205, 206 mount open and prevent the tote and products inside it from falling through side opening 211.

A second 1206 view shows a cross-section of the bracket 1201. The bracket 1201 edges are rounded, so it will not tear a plastic bag or another kind of tote. Alternatively, bracket 1201 may include two grooves formed in the edge of container 213. In this known practice, the grooves support the handle of the plastic bag when the handle is placed in the grooves in such a way that the handle passes through the both grooves.

FIG. 12B shows a set of repositories 1211 which acts as an alternative to separated containers 213. In the set of repositories 1211 the space defined by an outer wall 1212 of is divided by at least one intermediate wall 1213 into repositories, including the repository 302. In the example shown in the figure two intermediate walls 1213 divide the space into three repositories which can be considered as containers. Each of the containers 213 is adapted to support one tote 205, 206 by means of brackets (such as bracket 1206). The set of repositories 1201 may be permanently attached to the cart 310. Alternatively, it may be a detachable part.

FIG. 13 shows a bird's eye view of a wall 301. In previous examples, wall 301 is solid, stationary piece, but it may as well remind a sliding door or a hinged door as in this figure. Wall 301 includes openings and closures so that closure 307 is adapted to cover opening 304. A system 1301 includes a parking place 309 for cart 310. Parking place 309 is located besides a concrete wall or a corresponsive solid wall 1302. In the figure wall 301 has been opened using hinges 1303 and a handle 1304 and therefore cart 310 has an access route to a parking place 309. When cart 310 is received to the parking place 309, and wall 301 is moved to its closed position, and the closure 307 is opened, repository 302 in cart 310 is accessible through opening 304.

While the present invention has been described in connection with a number of exemplary embodiments, and implementations, the present invention is not so limited, but rather covers various modifications, and equivalent arrangements, which fall within the purview of prospective claims.

1-15. (canceled)

16. A system for storing products, the system comprising:
A first and a second opposing walls, each having a plurality of openings at least two of the openings having corresponding openable closures, the walls being spaced apart in relation to one another and defining a parking place therebetween;
a cart having at least a first, second, third and fourth repositories for totes, a repository comprising a mouth for receiving at least one product into a tote, the repository further comprising a bottom and a side between the mouth and the bottom such that the side is inclined in relation to a horizontal plane to keep said at least one product in the tote, the side extending upwards from the horizontal plane towards a lower edge of the mouth;
the cart being dimensioned such that when placed in the parking place at least the first and second repositories are in registration with corresponding openings of the first wall and the third and fourth repositories are in registration with corresponding openings on the second wall, and opening a corresponding closure allows removing at least one of the totes from a corresponding repository.

17. The system as claimed in claim 16, wherein the side is inclined at least 45 degrees in relation to the horizontal plane.

18. The system as claimed in claim 16, wherein the first repository and the second repository are tilted at most 45 degrees from a vertical plane.

19. The system as claimed in claim 16, wherein opposite repository sides around the mouth are dimensioned to support opposite sides of the tote.

20. The system as claimed in claim 16, wherein the system comprises a door attached with hinges to an edge of either of the walls, the door being intended for keeping the cart in the parking place.

21. The system as claimed in claim 16, wherein the first repository and the second repository are placed in a 45-degree angle to the horizontal plane.

22. The system as claimed in claim 16, wherein the third repository and the fourth repository are placed in a 45-degree angle to the horizontal plane.

23. The system as claimed in claim 16, wherein the first repository, the second repository, the third repository, and the fourth repository partly overlap.

24. The system as claimed in claim 16, wherein the system comprises an encapsulation and a cooling arrangement.

25. The system as claimed in claim 16, wherein the system comprises an identifier for indicating the parking place.

26. The system as claimed in claim 16, wherein the system is configured to check by a control unit which repositories are reserved and to deem the cart to be free when the all repositories in the cart are empty.

27. A system for storing products, the system comprising:
A wall having a plurality of openings and a parking place besides the wall, at least two of the openings having corresponding openable closures;
a cart having a first and a second repositories for totes, a repository comprising a mouth and a side opening, the mouth being dimensioned to enable receiving at least one product into a tote and the side opening being dimensioned to enable removing the tote from the repository;
the cart further having a fixed shelf, a movable shelf, and a displacer for horizontally moving the movable shelf between an open state and a closed state, the moveable shelf being arranged above the fixed shelf such that while in the open position the moveable shelf exposes at least a portion of a tote mouth in the second repository;
the cart being dimensioned such that when placed in the parking place at least the first repository and the second repository are in registration with corresponding openings of the wall, and opening a closure allows removing at least one of the totes from a corresponding repository.

28. The system as claimed in claim 27, wherein opposite repository sides around the mouth are dimensioned to support opposite sides of the tote.

29. The system as claimed in claim 27, wherein the cart is configured to a picking usage so that the displacer remains in the open position when moving the cart during the picking stage.

30. The system as claimed in claim 27, wherein the system comprises a guide for guiding the cart to the parking place.

31. The system as claimed in claim 27, wherein the system comprises a fastening arrangement for fastening the cart to the wall.

32. The system as claimed in claim 27, wherein the system comprises a locking arrangement for locking the cart to the parking place.

33. The system as claimed in claim 27, wherein the system comprises an encapsulation and a cooling arrangement.

34. The system as claimed in claim 27, wherein the system comprises an identifier for indicating the parking place.

35. The system as claimed in claim 27, wherein the system is configured to check by a control unit which repositories are reserved and to deem the cart to be free when the all repositories in the cart are empty.
